(19) United States
(12) Patent Application Publication
(10) Pub. No.: US 2011/0221722 A1
(43) Pub. Date: Sep. 15, 2011

(54) DISPLAY DEVICE AND ACTIVE MATRIX SUBSTRATE

(75) Inventors: Keisuke Yoshida, Osaka (JP); Kazuhiro Maeda, Osaka (JP); Ryoji Yayotani, Osaka (JP); Masahiro Fujiwara, Osaka (JP)

(73) Assignee: SHARP KABUSHIKI KAISHA, Osaka (JP)

(21) Appl. No.: 13/128,805

(22) PCT Filed: Aug. 12, 2009
(86) PCT No.: PCT/JP2009/064220

§ 371 Date: May 11, 2011

(30) Foreign Application Priority Data
Nov. 20, 2008 (JP) 2008-296961

(51) Int. Cl. G09G 3/36; G06F 3/038; G02F 1/1333; G02F 1/1343

(52) U.S. Cl. 345/206; 349/116; 345/87

(57) ABSTRACT

Provided is a display device equipped with a display panel having an optical sensor built in a pixel. The display device is equipped with the display panel having a photo sensor element (107) as the optical sensor in a pixel. The pixel includes: a first layer having the photo sensor element (107); a second layer having a first shield electrode (108); and a third layer having a pixel electrode (106). The second layer is formed between the first layer and the third layer. The first shield electrode (108) covers the photo sensor element (107) and is insulated from the pixel electrode (106). This configuration can reduce the effects of the electrical noise on the optical sensor and prevents lowering of the sensibility of the optical sensor. The present invention can be applied to a liquid crystal display panel having a built-in optical sensor touch panel and a liquid crystal display panel having a built-in optical sensor scanner function.

### TECHNICAL FIELD

The present invention relates to a display device equipped with a display panel having an optical sensor built in a pixel.

### BACKGROUND ART

Up to now, display devices equipped with a display panel having an optical sensor built in a pixel have been presented.

A photodiode is commonly used as an optical sensor for the above-mentioned display devices. The sensibility of a photodiode is generally expressed with S (Signal)/N (Noise). That is, the larger S/N value means the better sensibility.

As a method to improve the sensibility of an optical sensor for a display panel having an optical sensor built in a pixel, a technique that improves S (Signal)/N (Noise) by forming two photodiodes in a pixel to increase photo current is disclosed in Patent Document 1, for example. That is, the technique disclosed in Patent Document 1 improves the sensibility by increasing photo current representing S (signal) of S/N expressing the sensibility of a photodiode.

### RELATED ART DOCUMENTS

### Patent Documents

Patent Document 1: Japanese Patent Application Laid-Open Publication No. 2006-003857 (Publication date: Jan. 5, 2006)

### SUMMARY OF THE INVENTION

### Problems to be Solved by the Invention

A photodiode used in the above-mentioned display device as an optical sensor is susceptible to noise (electrical noise) caused by a potential change at a pixel electrode in a pixel. Here, the value of N (Noise), a denominator of S/N expressing the sensibility of a photodiode, is increased, creating a problem of lowering of the sensibility.

For example, in Patent Document 1, there are two photodiodes formed in a pixel to increase photo current (S) in order to improve the sensibility of a photodiode. However, the affected noise (N) is also increased because there are more photodiodes, resulting in a problem of lowering of the sensibility of an optical sensor.

The present invention is provided given the above-mentioned problem, and the object of the invention is to achieve a display device that can prevent lowering of the sensibility of an optical sensor by reducing the effects of the electrical noise on an optical sensor.

### Means for Solving the Problems

In order to solve the above-mentioned problem, a display device of the present invention is equipped with a display panel having an optical sensor built in a pixel, wherein the above-mentioned pixel includes a first layer having the above-mentioned optical sensor, a second layer having a first shield electrode, and a third layer having a pixel electrode. The above-mentioned second layer is formed between the above-mentioned first layer and the above-mentioned third layer. The above-mentioned first shield electrode covers the above-mentioned optical sensor, and is insulated from the above-mentioned pixel electrode.

An active matrix substrate of the present invention is made of an active matrix substrate having switching elements for individually driving respective pixels arranged in a matrix, wherein the above-mentioned pixel includes a first layer having an optical sensor, a second layer having a first shield electrode, and a third layer having a pixel electrode. The above-mentioned second layer is formed between the above-mentioned first layer and the above-mentioned third layer. The above-mentioned first shield electrode covers the above-mentioned optical sensor, and is insulated from the above-mentioned pixel electrode.

In the above-mentioned configuration, the first shield electrode covering the optical sensor is formed between the optical sensor and the pixel electrode, and this first shield electrode is insulated from the pixel electrode. Therefore, the effects of the electrical noise caused by a potential change at the pixel electrode are blocked by the first shield electrode, and do not reach the optical sensor. Moreover, the pixel electrode and the first shield electrode can overlap because the pixel electrode and the first shield electrode are formed in different layers, enabling a larger transmissive aperture area, and preventing the light leakage due to an orientation disorder of liquid crystal molecules. Thus, the effects of the electrical noise on the optical sensor can be reduced, and lowering of the sensibility of the optical sensor can be prevented. As a result, a better sensibility of the optical sensor can be achieved compared to the conventional display panels having a built-in optical sensor.

Therefore, if a display device or an active matrix substrate of the present invention is used for a liquid crystal display device having a built-in optical sensor touch panel, recognition accuracy in user's touch control improves because of the better sensibility of the optical sensor, and an improved operation performance of a touch panel can be achieved.

It is also preferable that a predetermined potential be applied to the above-mentioned first shield electrode.

In the above-mentioned configuration, because a certain potential be applied to the first shield electrode, it is possible to reduce a potential change due to other signals and external noise affecting the first shield electrode itself. This further ensures the elimination of the effects of the electrical noise on an optical sensor. That is, in this case, the first shield electrode prevents noise from entering to the optical sensor because the first shield electrode is formed in a layer between the optical sensor and the pixel electrode.

It is also preferable that the above-mentioned first shield electrode be transparent.

It is also preferable that the transmittance of the above-mentioned first shield electrode as a single electrode film be 80% or more at a wavelength range of 400 to 700 nm.

In the above-mentioned configuration, the area corresponding to the optical sensor can also contribute to a transmissive display because the first shield electrode is transparent. It is also not necessary to form an opening on the first shield electrode in the area corresponding to the optical sensor, thereby further ensuring the reduction of the effects of the electrical noise. Moreover, it is not necessary to additionally form a transparent electrode or the like on the third layer having pixel electrodes because the first shield electrode completely covers the optical sensor, and therefore, a pixel electrode can be arranged widely. As a result, it is possible to efficiently orient liquid crystal molecules, preventing light leakage caused by an orientation disorder of liquid crystal molecules, and achieving a higher aperture ratio.

It is also preferable that the above-mentioned pixel electrode cover the above-mentioned first shield electrode.

In the above-mentioned configuration, the pixel electrode further covers the first shield electrode covering the optical sensor, and thus, liquid crystal molecules over the optical sensor can be driven normally to contribute to a transmissive display.

It is also preferable to form a light shielding element that prevents light from entering to the edges of the light-receiving area of the above-mentioned optical sensor.

In the above-mentioned configuration, it is possible to prevent light from entering to the edges of the light-receiving area of the optical sensor. Therefore, stray light can be prevented from entering to the optical sensor.

It is also preferable that the above-mentioned first shield electrode be non-transparent.

In the above-mentioned configuration, the first shield electrode is non-transparent, and thus, it also prevents light from entering to the edges of the light-receiving area of the optical sensor. Therefore, it is possible to further reduce the effects of the optical noise due to light leakage and light diffraction caused by an orientation disorder of liquid crystal on the optical sensor. Furthermore, infrared light can also be prevented from entering to the optical sensor if a metal or the like that can block infrared light is used, for example.

It is also preferable that the above-mentioned first shield electrode have an opening in the area corresponding to the light-receiving area of the above-mentioned optical sensor.

In the above-mentioned configuration, because the first shield electrode has an opening in the area corresponding to the light-receiving area of the optical sensor, it does not interfere with the light entering to the optical sensor. Moreover, the first shield electrode is formed near the optical sensor, and thus, alignment accuracy is high and there is no need to keep a margin in the opening more than necessary.

It is also preferable to further include a second shield electrode covering the above-mentioned opening, and that the above-mentioned second shield electrode be transparent and be also insulated from the above-mentioned pixel electrode.

It is also preferable that the transmittance of the above-mentioned second shield electrode as a single electrode film be 80% or more at a wavelength range of 400 to 700 nm.

In the above-mentioned configuration, the opening in the first shield electrode is covered by the second shield electrode that is insulated from the pixel electrode, and thus, the effects of the electrical noise on the optical sensor can be reduced. Additionally, the second shield electrode is transparent and therefore does not interfere with the light entering to the optical sensor.

It is also preferable that the above-mentioned second shield electrode be formed on the above-mentioned third layer.

In the above-mentioned configuration, the second shield electrode and the pixel electrode are formed on the same layer, and thus, the second shield electrode and the pixel electrode can be formed during the same step. Specifically, after forming an electrode layer that will respectively become the pixel electrode and the second shield electrode, it can be patterned into predetermined respective patterns. Therefore, the manufacturing process of a display device can be simplified.

It is also preferable that a predetermined potential be applied to the above-mentioned second shield electrode.

In the above-mentioned configuration, because a certain potential is applied to the second shield electrode, it is possible to reduce a potential change due to other signals, external noise and the like affecting the second shield electrode itself. This further ensures the elimination of the effects of the electrical noise on the optical sensor.

It is also preferable that the above-mentioned respective second shield electrodes in respective pixels be electrically connected to each other.

An optical sensor is affected not only by the electrical noise at the pixel electrode, but also by other signals, external noise and the like. However, it is possible to disperse the effects of other signals, external noise and the like on the optical sensor because the respective second shield electrodes are electrically connected to each other in the above-mentioned configuration. As a result, the optical sensor becomes insusceptible to these effects.

It is also preferable that the above-mentioned second shield electrode be connected to the above-mentioned first shield electrode.

In the above-mentioned configuration, because the second shield electrode and the first shield electrode are electrically connected, it is possible to disperse the effects of other signals, external noise and the like on the optical sensor, and to further reduce these effects on the optical sensor.

It is preferable that the above-mentioned display panel be in normally black mode, and include an opposite substrate having an opposite electrode formed on a surface that faces a pixel electrode formed surface of a substrate on which the above-mentioned pixel electrodes are formed. It is also preferable that the potential of the above-mentioned second shield electrode be set so that the potential difference with the above-mentioned opposite electrode is 0V or more and 2V or less.

In the above-mentioned configuration, the potential difference between the second shield electrode and the opposite electrode is set to be 0V or more and 2V or less when a display panel is in normally black mode. Because of this, liquid crystal orientation on the second shield electrode is in a black display state, and therefore, high display quality without lowering of contrast can be achieved.

It is also preferable that the above-mentioned display panel be in normally white mode, and include an opposite substrate having an opposite electrode formed on a surface that faces a pixel electrode formed surface of a substrate on which the above-mentioned pixel electrodes are formed. It is also preferable that the potential of the above-mentioned second shield electrode be set so that the potential difference with the above-mentioned opposite electrode is 2V or more and 10V or less.

In the above-mentioned configuration, the potential difference between the second shield electrode and the opposite electrode is set to be 2V or more and 10V or less when a display panel is in normally white mode, and thus, the liquid crystal orientation on the second shield electrode is in a black display state, and therefore, high display quality without lowering of contrast can be achieved.

### Effects of the Invention

As described above, a display device of the present invention is equipped with a display panel having an optical sensor built in a pixel. The above-mentioned pixel includes a first layer having the above-mentioned optical sensor, a second layer having a first shield electrode, and a third layer having a pixel electrode. The above-mentioned second layer is formed between the above-mentioned first layer and the above-mentioned third layer. The above-mentioned first shield electrode covers the above-mentioned optical sensor, and is insulated from the above-mentioned pixel electrode, preventing lowering of the sensibility of the optical sensor. As a result, the better sensibility of the optical sensor can be achieved compared to the conventional display panel having a built-in optical sensor.

Therefore, when a display device of the present invention is used for a liquid crystal display device having a built-in optical sensor touch panel, recognition accuracy in user's touch control improves because of the better sensibility of the optical sensor, and an improved operation performance of a touch panel can be achieved.

The other objects, characteristics, and merits of the present invention should be sufficiently apparent from the following description. The advantages of the present invention should also be clear from the following description with reference to the attached figures.

### BRIEF DESCRIPTION OF THE DRAWINGS

FIG. 1 is a plan view of a liquid crystal display device of a preferred embodiment of the present invention.

FIG. 2 is a cross-sectional view along the line A-A of the liquid crystal display device shown in FIG. 1.

FIG. 3 is a plain view of a liquid crystal display device of another preferred embodiment of the present invention.

FIG. 4 is a cross-sectional view along the line B-B of the liquid crystal display device shown in FIG. 3.

FIG. 5 shows a comparative example of a liquid crystal display device of the present preferred embodiment.

### DETAILED DESCRIPTION OF EMBODIMENTS

The present invention is not limited to the following respective preferred embodiments. Various modifications are possible within the scope described in claims, and preferred embodiments obtained by properly combining the technical means disclosed in different preferred embodiments are also included in the technical scope of the present invention.

### Embodiment 1

A preferred embodiment of the present invention will be described as follows. The present embodiment describes an example in which a display device of the present invention is used in a liquid crystal display device having a built-in optical sensor touch panel.

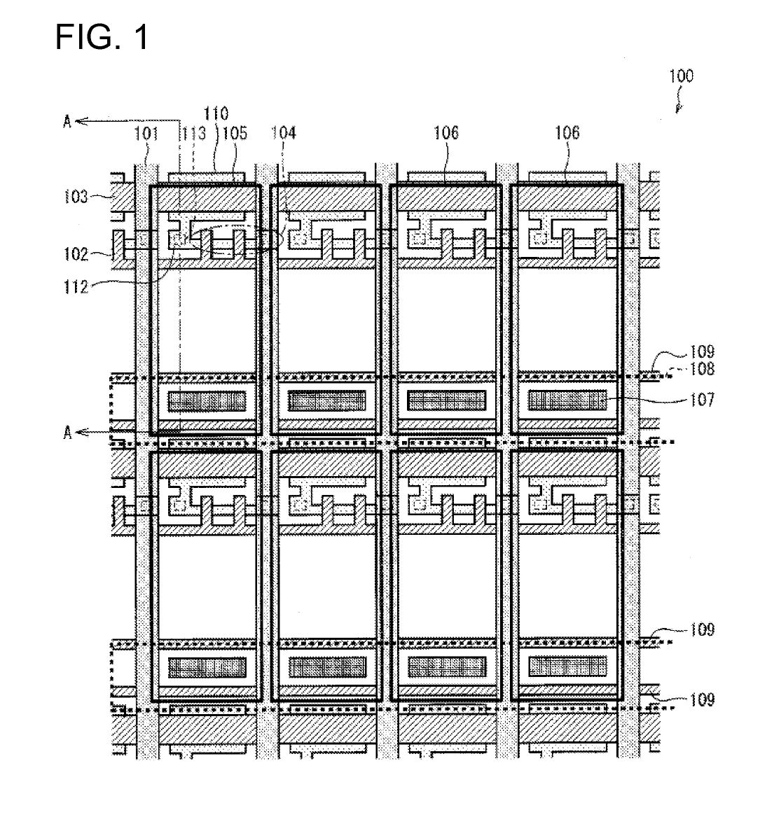

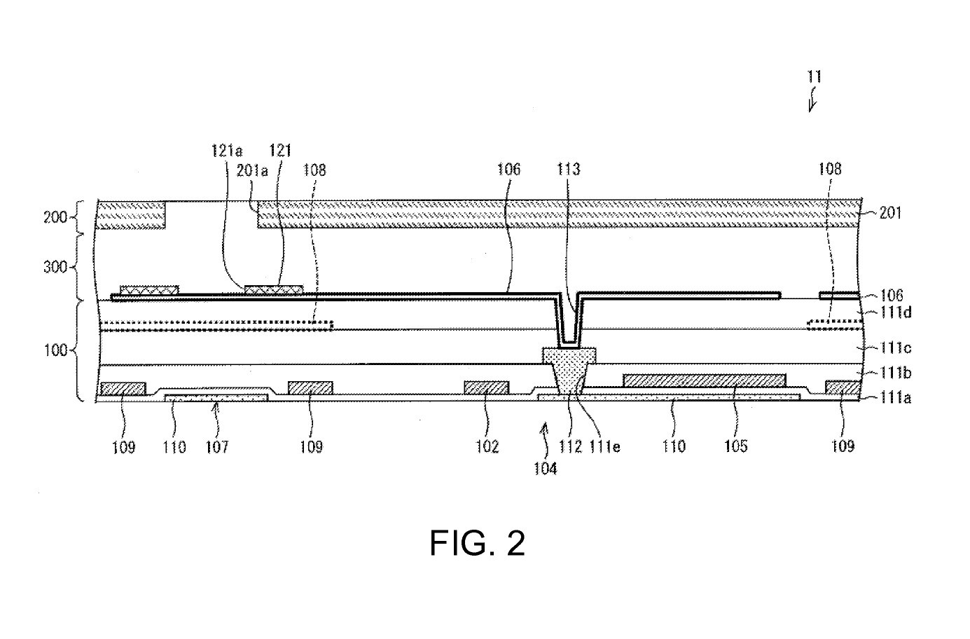

The overall configuration of a liquid crystal display device of the present embodiment will be described below with reference to FIG. 1 and FIG. 2.

FIG. 1 is a plain view of a liquid crystal display device of a preferred embodiment of the present invention. In FIG. 1, for convenience of description, only the side of an active matrix substrate (hereinafter referred to as “TFT (Thin Film Transistor) array substrate”) 100 is shown, and a liquid crystal layer 300 and an opposite substrate 200 are omitted.

FIG. 2 is a cross-sectional view along the line A-A of a liquid crystal display device shown in FIG. 1. The liquid crystal layer 300 and the opposite substrate 200 are also illustrated in addition to the TFT array substrate 100 in FIG. 2. That is, as shown in FIG. 2, a liquid crystal display device 11 of the present embodiment has a structure in which the liquid crystal layer 300 is held between the TFT array substrate 100 and the opposite substrate 200 that faces this TFT array substrate 100.

First, the TFT array substrate 100 will be described.

The TFT array substrate 100 includes pixel electrodes 106 and photo sensor elements (optical sensors) 107, as shown in FIG. 1.

The pixel electrodes 106 and the photo sensor elements 107 are arranged in a matrix on an insulating substrate not shown in the figure, and one pixel electrode 106 and one photo sensor element 107 constitute one pixel. That is, the TFT array substrate 100 has a structure in which one photo sensor element 107 is also built within one pixel along with one pixel electrode 106.

Furthermore, it is preferable that the TFT array substrate (the active matrix substrate) include switching elements to individually drive respective pixels arranged in a matrix.

The pixel electrode 106 is electrically connected through a contact hole 113 to a drain electrode 112 of a TFT 104 formed at the intersection of a source bus line 101 and a gate bus line 102 that is perpendicular to this source bus line 101.

The drain electrode 112 is electrically connected to a silicon layer 110.

A CS bus line 103 and wires for photo sensors 109 are formed substantially in parallel with the gate bus line 102.

The CS bus line 103 has a CS electrode 105 formed in every pixel, and this CS electrode 105 and the silicon layer 110 constitute an auxiliary capacitance.

The wires for photo sensors 109 are wires transmitting signals controlling a sensing circuit made of the photo sensor element 107 and the TFT 104 that is connected to the photo sensor element 107.

The photo sensor element 107 is a photoelectric conversion element that converts received light to current, and is made of a photodiode, for example, and supplies the amount of current in accordance with the amount of the received light to the wire for photo sensors 109. Therefore, it is possible to detect the amount of the light received per pixel.

A layer having a first shield electrode 108 (a second layer) is formed between a layer having a photo sensor element 107 (a first layer) and a layer having a pixel electrode 106 (a third layer). This first shield electrode 108 is formed so as to cover the photo sensor element 107, and is insulated from the pixel electrode 106. Therefore, the first shield electrode 108 suppresses the effects of the noise on the photo sensor element 107 caused by a potential change or the like at the pixel electrode 106.

The first shield electrode 108 is made of a transparent electrode unitarily formed along the wire for photo sensors 109 so as to cover a plurality of the photo sensor elements 107 adjacent thereto. This first shield electrode 108 is connected to a power source not shown in the figure, and a predetermined potential is applied to it at all times.

It is preferable that the first shield electrode 108 of the present embodiment be transparent. It is also preferable that the transmittance of the first shield electrode 108 as a single electrode film be 80% or more at a wavelength range of 400 to 700 nm, which is a visible light range.

In the above-mentioned configuration, the area corresponding to the photo sensor element 107 can also contribute to a transmissive display because the first shield electrode 108 is transparent. Additionally, because it is not necessary to form an opening in the first shield electrode 108 in the area corresponding to the photo sensor element 107, the effects of the electrical noise can be more certainly reduced. Moreover, there is no need to additionally form a shield electrode such as a transparent electrode on the third layer having the pixel electrode 106 because the first shied electrode 108 completely covers the photo sensor element 107, and thus, the pixel electrode 106 can be arranged widely. As a result, it is possible to efficiently orient liquid crystal molecules, preventing light leakage caused by an orientation disorder of liquid crystal molecules, and achieving a higher aperture ratio.

It is also preferable that the pixel electrode 106 be formed so as to cover the first shield electrode 108, as shown in FIG. 1. In the above-mentioned configuration, because the pixel electrode 106 further covers the first shield electrode 108 covering the photo sensor element 107, liquid crystal molecules on the photo sensor element 107 can be driven normally to contribute to a transmissive display.

As shown in FIG. 2, the TFT array substrate 100 includes a first insulating film 111a laminated so as to cover the photo sensor element 107 and the silicon layer 110 that have been formed via a patterning or the like on a surface opposite to the surface on which the pixel electrodes 106 are formed (a pixel electrode formed surface), that is, in a layer on the insulating substrate at the very bottom layer (in a first layer) (not shown in the figure). Respective wires (a gate bus line 102, wires for photo sensors 109) and a CS electrode 105 are formed on this first insulating film 111a. A second insulating film 111b is further laminated so as to cover the above-mentioned respective wires and CS electrodes 105.

A drain electrode 112 that constitutes the TFT 104 is formed on the second insulating film 111b. This drain electrode 112 is electrically connected to the silicon layer 110, which is located right below the pixel electrode 106, through a contact hole 111e formed on the first insulating film 111a and the second insulating film 111b.

Furthermore, a third insulating film 111c is laminated on the second insulating film 111b so as to cover the drain electrode 112. A first shield electrode 108 is formed in a layer on the third insulating film 111c (a second layer).

A fourth insulating film 111d is further laminated on the third insulating film 111c so as to cover the first shield electrode 108. A pixel electrode 106 is formed in a layer on the fourth insulating film 111d (a third layer). This pixel electrode 106 is electrically connected to the drain electrode 112 through a contact hole 113 that has been formed in the third insulating film 111c and in the fourth insulating film 111d.

Moreover, a light shielding element 121 having a light shielding element opening 121a is formed on the upper surface of the pixel electrode 106 in the area corresponding to the photo sensor element 107. The opening width of the light shielding element opening 121a is narrower than the width of a color filter layer opening 201a of a color filter layer 201 on an opposite substrate 200, which will be described later, and is wider than the width of the light-receiving area of the photo sensor element 107. Therefore, stray light can be prevented from entering to the photo sensor element 107.

The position of the light shielding element 121 is not limited to the upper surface of the pixel electrode 106, but any position that can prevent stray light from entering to the photo sensor element 107 is acceptable. For example, it can be on the first shield electrode 108, or on the opposite substrate 200, which will be described later.

Next, the opposite substrate 200 will be described.

As shown in FIG. 2, a transparent insulating substrate not shown in the figure, is formed on the very top surface of the opposite substrate 200, and a color filter layer 201 is formed on the insulating substrate. This color filter layer 201 is set to the RGB setting in order to correspond to the respective pixels of the TFT array substrate 100.

Moreover, a color filter layer opening 201a is formed in the color filter layer 201 in the area corresponding to the photo sensor element 107 of the TFT array substrate 100.

Furthermore, the color filter layer 201 has an opposite electrode (not shown in the figure) formed in the area facing the pixel electrode 106, on the surface facing a liquid crystal layer 300, that is, on a surface facing the surface of the TFT array substrate 100 on which the pixel electrodes are formed.

Although not shown in FIG. 2, an alignment film to control an alignment of liquid crystal is formed on the opposite electrode located on the surface of the opposite substrate 200 facing the liquid crystal layer 300. An alignment film to control an alignment of liquid crystal is also formed on the pixel electrode 106 of the TFT array substrate 100.

The liquid crystal display device 11 described above is a transmissive liquid crystal display device, but the present invention can be applied not only to such a transmissive liquid crystal display device, but also to a semi-transmissive liquid crystal display device.

As described above, the liquid crystal display device 11 of the present embodiment is equipped with a display panel having a photo sensor element 107 as an optical sensor built in a pixel. The above-mentioned pixel includes a first layer having the above-mentioned photo sensor element 107, a second layer having a first shield electrode 108, and a third layer having a pixel electrode 106. The above-mentioned second layer is formed between the above-mentioned first layer and the above-mentioned third layer. The above-mentioned first shield electrode 108 covers the above-mentioned photo sensor element 107, and is insulated from the above-mentioned pixel electrode 106.

In the above-mentioned configuration, the first shield electrode 108 is formed between the photo sensor element 107 and the pixel electrode 106 so as to cover the photo sensor element 107, and this first shield electrode 108 is insulated from the pixel electrode 106. Accordingly, the effects of the electrical noise caused by a potential change at the pixel electrode 106 are blocked by the first shield electrode 108, and do not reach the photo sensor element 107. The pixel electrode 106 and the first shield electrode 108 can overlap because the pixel electrode 106 and the first shield electrode 108 are formed in different layers. This enables a larger transmissive aperture area, and prevents light leakage caused by an orientation disorder of liquid crystal molecules. Furthermore, the effects of the optical noise caused by stray light on the photo sensor element 107 can be reduced by having the first shield electrode 108. Therefore, the effects of electrical and optical noise on the photo sensor element 107 can be reduced, preventing lowering of the sensibility of the photo sensor element 107. As a result, the sensibility of the photo sensor element 107 as an optical sensor can be improved compared to the conventional display panels having a built-in optical sensor. There is also no need to keep a margin more than necessary because the alignment accuracy is high.

Therefore, when a display device of the present invention is used for a liquid crystal display device having a built-in optical sensor touch panel, recognition accuracy in user's touch control improves because of the better sensibility of the optical sensor, and an improved operation performance of a touch panel can be achieved.

### Embodiment 2

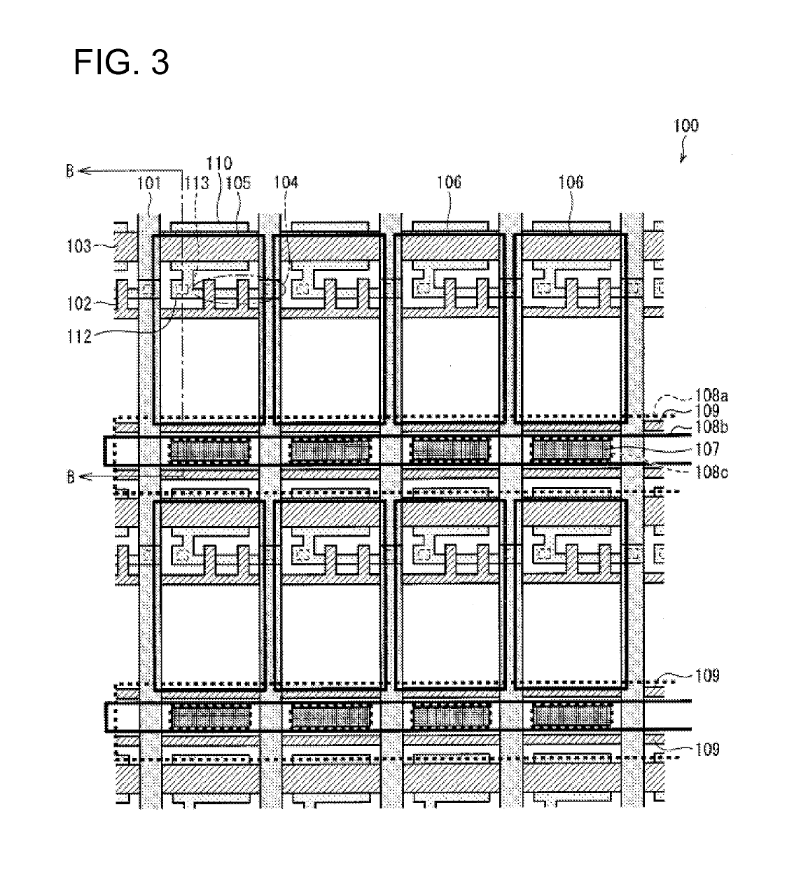

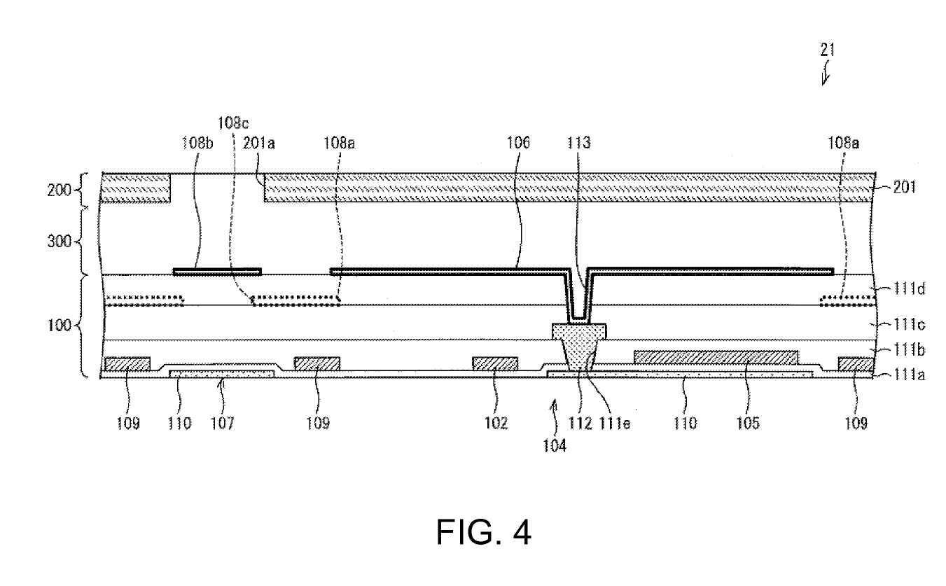

Next, another preferred embodiment of the present invention will be described below with reference to FIG. 3 and FIG. 4.

FIG. 3 is a plain view of a liquid crystal display device of another embodiment of the present invention, and FIG. 4 is a cross-sectional view along the line B-B of the liquid crystal display device shown in FIG. 3.

In Embodiment 2, the configuration is same as Embodiment 1 except for the aspects that the first shield electrode 108a is non-transparent and includes a first shield electrode opening 108c, a second shield electrode 108b is formed, and a light shielding element 121 is not formed. Therefore, only the aspects different from Embodiment 1 will be explained in this embodiment. The same reference numerals are used for the members of the similar structures, and their description will be omitted.

A first shield electrode 108a of the present embodiment is non-transparent, and includes a first shield electrode opening 108c, as shown in FIG. 3.

In the present specification, “non-transparent” means transmittance is 1% or less, more preferably, 0.1% or less.

It is preferable that a metal having both conductive characteristics and light shielding characteristics be used for the first shield electrode 108a of the present embodiment. Although not limited, a metal such as tantalum (Ta), titanium (Ti), and aluminum (Al) can be used, for example. It is also preferable that a metal that can block infrared light be used for the first shield electrode 108a. In the above-mentioned configuration, infrared light can also be prevented from entering to the photo sensor element 107.

In the present embodiment, the first shield electrode 108a is non-transparent. Therefore, it also prevents light from entering to the edges of the light-receiving area of the photo sensor element 107. Therefore, it is possible to further reduce the effects of the optical noise due to light leakage, stray light and the like caused by an orientation disorder of liquid crystal on the photo sensor element 107.

The first shield electrode opening 108c is formed in the first shield electrode 108a in the area corresponding to the light-receiving area of the photo sensor element 107. The first shield electrode 108a does not interfere with the light entering to the photo sensor element 107 because the first shield electrode opening 108c is formed.

The second shield electrode 108b, which covers the first shield electrode opening 108c, is formed in the same layer as the pixel electrodes 106. The second shield electrode 108b is transparent, and is also insulated from the pixel electrode 106.

It is preferable that the transmittance of the second shield electrode 108b as a single electrode film be 80% or more at a wavelength range of 400 to 700 nm, which is a visible light range.

The second shield electrode 108b covers the first shield electrode opening 108c, and is also insulated from the pixel electrode 106. Therefore, the effects of the electrical noise on the photo sensor element 107 can be reduced. Additionally, because the second shield electrode 108b is transparent, it does not interfere with the light entering to the photo sensor element 107.

If the second shield electrode 108b and the pixel electrode 106 are formed in the same layer as in the present embodiment, the second shield electrode 108b and the pixel electrode 106 can be formed during the same step. That is, after forming an electrode layer that will become the pixel electrode 106 and the second shield electrode 108b, it can be patterned into respective patterns. Therefore, the manufacturing process of a display device can be simplified.

In terms of simplification of the manufacturing process, it is preferable that the pixel electrode 106 and the second shield electrode 108b be formed in the same layer as described above. However, in terms of shielding the photo sensor element 107 from noise, it is not necessary to form the pixel electrode 106 and the second shield electrode 108b in the same layer, and it is acceptable to form them in different layers.

As shown in FIG. 3, the second shield electrode 108b is made of a transparent electrode unitarily formed along the wire for photo sensors 109 so as to cover a plurality of the photo sensor elements 107 adjacent thereto. This second shield electrode 108b is connected to a power source not shown in the figure, and a predetermined potential is applied to it at all times. In the above-mentioned configuration, because a certain potential is applied to the second shield electrode 108b, it is possible to reduce a potential change due to other signals, external noise and the like, affecting the second shield electrode 108b itself. This further ensures the elimination of the effects of the electrical noise on the photo sensor element 107.

Furthermore, it is preferable that the respective second shield electrodes 108b in respective pixels be electrically connected to each other. It is further preferable that they be connected to the end of the panel, and be connected to a fixed potential at the end of the panel. The second shield electrode 108b may be formed in an island shape across one or multiple pixels. The photo sensor element 107 is affected not only by the electrical noise at the pixel electrode, but also by other signals, external noise and the like. However, it is possible to disperse the effects of other signals, external noise and the like on the photo sensor element 107 because the respective second shield electrodes 108b are electrically connected to each other. As a result, the photo sensor element becomes insusceptible to these effects.

The second shield electrode 108b may be connected to the first shield electrode 108a through a small shield electrode or the like. The respective second shield electrodes 108b may be formed in respective first shield electrode openings 108c, and connected to the near first shield electrode 108a. In the above-mentioned configuration, because the second shield electrode 108b and the first shied electrode 108a are electrically connected, the effects of other signals and external noise on the photo sensor element 107 can be further dispersed and reduced.

The pixel electrode 106 and the first shield electrode 108a are formed so as to overlap each other in the present embodiment. Therefore, it is possible to broaden the transmissive aperture area, and to prevent light leakage caused by an orientation disorder of liquid crystal molecules.

Additionally, in the present embodiment, in cases where a display panel is in normally black mode, for example, it is preferable that the potential of the second shield electrode 108b be set so that the potential difference with the opposite electrode is 0V or more and 2V or less. In the above-mentioned configuration, the liquid crystal orientation on the second shield electrode 108b is in a black display state. Accordingly, high display quality without lowering of contrast can be achieved.

Moreover, in the present embodiment, in cases where a display panel is in normally white mode, for example, it is preferable that the potential of the second shield electrode 108b be set so that the potential difference with the opposite electrode is 2V or more and 10V or less. In the above-mentioned configuration, the liquid crystal orientation on the second shield electrode 108b is in a black display state. Therefore, high display quality without lowering of contrast can be achieved.

### Comparative Example 1

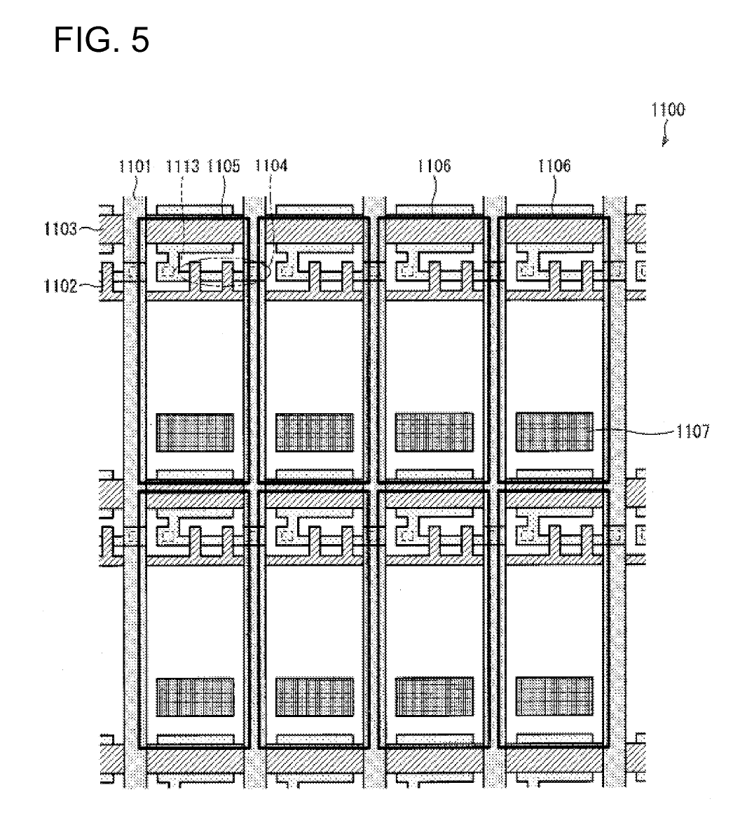

Here, a comparative example of the present embodiment will be described below with references to FIG. 5.

FIG. 5 shows a comparative example of a liquid crystal display device of the present embodiment.

A TFT array substrate 1100 of a liquid crystal display device of the present comparative example shown in FIG. 5 has the same configuration as the TFT array substrate 100 of Embodiment 1 shown in FIG. 1 except that the TFT array substrate 1100 does not have the first shield electrode 108. Although each reference numeral is changed to 1000s, the function remains the same. For example, a source bus line 1101 corresponds to a source bus line 101, a gate bus line 1102 corresponds to a gate bus line 102, a CS bus line 1103 corresponds to a CS bus line 103, a TFT 1104 corresponds to a TFT 104, a CS electrode 1105 corresponds to a CS electrode 105, a pixel electrode 1106 corresponds to a pixel electrode 106, and a photo sensor element 1107 corresponds to a photo sensor element 107.

As shown in FIG. 5, when a photo sensor element 1107 in a pixel is covered by a pixel electrode 1106, which is a transparent electrode, the photo sensor element 1107 is susceptible to the effects of the noise caused by a potential change at the pixel electrode 1106. As a result, N (Noise) component of S/N expressing the sensibility of the photo sensor element 1107 is increased, causing lowering of the sensibility of the photo sensor element 1107.

On the other hand, in a liquid crystal display device 11 of Embodiment 1, the TFT array substrate 100 includes the first shield electrode 108 that is formed between the photo sensor element 107 and the pixel electrode 106, and that is insulated from the pixel electrode 106 as shown in FIG. 1. Therefore, the potential change at the pixel electrode 106 is blocked by the first shield electrode 108, and does not reach the photo sensor element 107. This means the photo sensor element 107 is not affected by the noise caused by the potential change at the pixel electrode 106.

Additionally, as shown in FIG. 1, the first shield electrode 108 is made of a transparent electrode unitarily formed so as to cover all the adjacent photo sensor elements 107, and a predetermined potential is applied to the transparent electrode. Therefore, the effects of noise caused by a potential change at the pixel electrode 106 can certainly be suppressed.

As shown in FIG. 1 and FIG. 3, in liquid crystal display devices of Embodiment 1 and Embodiment 2, the first shield electrodes 108 and 108a are formed in a layer different from the layer in which the pixel electrodes 106 are formed. Therefore, the pixel electrode 106 and the first shield electrodes 108 and 108a can overlap. Thus, there is no need to form a space between the pixel electrodes 106, which contribute to a display, and the first shield electrodes 108 and 108a. As a result, it is possible to broaden a transmissive aperture area, and to prevent light leakage caused by an orientation disorder of liquid crystal molecules.

Furthermore, as shown in FIG. 3 and FIG. 4, the first shield electrode 108a is non-transparent in a liquid crystal display device of Embodiment 2. Therefore, it prevents light from entering to the edges of the light-receiving area of the optical sensor, minimizing the effects of the optical noise caused by light leakage and stray light due to an orientation disorder on the optical sensor. Especially, infrared light can also be prevented from entering to the optical sensor if a metal or the like that can block infrared light is used for the first shield electrode 108a.

The detailed preferred embodiments and examples described in the section of the detailed description of the invention are meant to explain the technical content of the present invention, and the present invention should not be interpreted narrowly to be limited to those embodiments. Various modifications within the spirit of the present invention and the scope of the following claims are acceptable.

### INDUSTRIAL APPLICABILITY

The present invention is applicable to display devices having an optical sensor built in a pixel in general, especially to a display device that needs to have an improved sensibility of an optical sensor, such as a liquid crystal display panel having a built-in optical sensor touch panel, and a liquid crystal display panel having a built-in optical sensor scanner function.

Description of Reference Characters

| | |
|---|---|
| 11 | liquid crystal display device |
| 100 | TFT array substrate |
| 101 | source bus line |
| 102 | gate bus line |
| 103 | CS bus line |
| 104 | TFT |
| 105 | CS electrode |
| 106 | pixel electrode |
| 107 | photo sensor element (optical sensor) |
| 108, 108a | first shield electrode |
| 108b | second shield electrode |
| 1008c | first shield electrode opening (opening) |
| 109 | wire for photo sensors |
| 110 | silicon layer |
| 111a | first insulating film |
| 111b | second insulating film |
| 111c | third insulating film |
| 111d | fourth insulating film |
| 111e | contact hole |
| 112 | drain electrode |
| 113 | contact hole |
| 121 | light shielding element |
| 121a | light shielding element opening |
| 200 | opposite substrate |
| 201 | color filter layer |
| 201a | color filter layer opening |
| 300 | liquid crystal layer |

1. A display device, comprising:
a display panel having an optical sensor built in a pixel,
wherein said pixel includes a first layer having said optical sensor, a second layer having a first shield electrode, and a third layer having a pixel electrode,
wherein said second layer is disposed between said first layer and said third layer, and
wherein said first shield electrode covers said optical sensor and is insulated from said pixel electrode.

2. The display device according to claim 1, wherein a predetermined potential is applied to said first shield electrode.

3. The display device according to claim 1, wherein said first shield electrode is transparent.

4. The display device according to claim 1, wherein electrode single film transmittance of said first shield electrode as a single electrode film is 80% or more at a wavelength range of 400 to 700 nm.

5. The display device according to claim 1, wherein said pixel electrode covers said first shield electrode.

6. The display device according to claim 1, further comprising a light shielding element that prevents light from entering to edges of a light-receiving area of said optical sensor.

7. The display device according to claim 1, wherein said first shield electrode is non-transparent.

8. The display device according to claim 7, wherein said first shield electrode includes an opening at a position corresponding to a light-receiving area of said optical sensor.

9. The display device according to claim 8, further comprising a second shield electrode covering said opening,
wherein said second shield electrode is transparent and is insulated from said pixel electrode.

10. The display device according to claim 9, wherein a transmittance of said second shield electrode as a single electrode film is 80% or more at a wavelength range of 400 to 700 nm.

11. The display device according to claim 9, wherein said second shield electrode is formed in said third layer.

12. The display device according to claim 9, wherein a predetermined potential is applied to said second shield electrode.

13. The display device according to claim 9, wherein said respective second shield electrodes in respective pixels are electrically connected to each other.

14. The display device according to claim 9, wherein said second shield electrode is electrically connected to said first shield electrode.

15. The display device according to claim 9, wherein said display panel is in normally black mode,
wherein the display device further comprises an opposite substrate having an opposite electrode formed on a surface that faces a pixel electrode formed surface of a substrate on which said pixel electrodes are formed, and
wherein a potential of said second shield electrode is set so that a potential difference with said opposite electrode is 0V or more and 2V or less.

16. The display device according to claim 9, wherein said display panel is in normally white mode,
wherein the display device further comprises an opposite substrate having an opposite electrode formed on a surface that faces a pixel electrode formed surface of a substrate on which said pixel electrodes are formed, and
wherein a potential of said second shield electrode is set so that a potential difference with said opposite electrode is 2V or more and 10V or less.

17. An active matrix substrate comprising:
switching elements for individually driving respective pixels arranged in a matrix,
wherein said pixel includes a first layer having an optical sensor, a second layer having a first shield electrode, and a third layer having a pixel electrode,
wherein said second layer is formed between said first layer and said third layer, and
wherein said first shield electrode covers said optical sensor and is insulated from said pixel electrode.
